(19) United States
(12) Patent Application Publication
(10) Pub. No.: US 2010/0228045 A1
(43) Pub. Date: Sep. 9, 2010

(54) BIOCOMPATIBLE SUSPENSION STABILIZER FOR DISPERSING INORGANIC NANOPARTICLES INTO AQUEOUS SOLUTION

(75) Inventors: Taeghwan Hyeon, Seoul (KR); Sang-Wook Kim, Suwon-si (KR); Hyon-Bin Na, Seoul (KR)

Correspondence Address: THE NATH LAW GROUP, 112 South West Street, Alexandria, VA, 22314, US

(73) Assignee: SEOUL NATIONAL UNIVERSITY INDUSTRY FOUNDATION, Seoul (KR)

(21) Appl. No.: 12/682,955

(22) PCT Filed: Oct. 15, 2008
(86) PCT No.: PCT/KR08/06063

§ 371 Date: Apr. 26, 2010

(30) Foreign Application Priority Data
Oct. 15, 2007 (KR) 10-2007-0103783

(51) Int. Cl. C07F 9/09; C07F 9/24; C07F 9/165; C07F 9/146

(52) U.S. Cl. 558/90; 558/171; 558/169; 558/180; 558/186; 558/89

(57) ABSTRACT

The present invention relates to a suspension stabilizer for dispersing inorganic nanoparticles into aqueous medium. More particularly, the present invention is directed to a biocompatible suspension stabilizer which comprises phosphoryl domain having an affinity to the surface of an inorganic nanoparticle and poly(ethylene glycol) having an affinity to the aqueous medium, and which is prepared by reacting a biocompatible poly(ethylene glycol)-derivatized polymer with phosphine oxide having a leaving group.

### TECHNICAL FIELD

The present invention relates to a suspension stabilizer for dispersing inorganic nanoparticles into aqueous medium. More particularly, the present invention is directed to a biocompatible suspension stabilizer which comprises phosphoryl domain having an affinity to the surface of an inorganic nanoparticle and poly(ethylene glycol) having an affinity to the aqueous medium, and which is prepared by reacting a biocompatible poly(ethylene glycol)-derivatized polymer with phosphine oxide having a leaving group.

### BACKGROUND ART

Nanoparticles have been used in a wide variety of applications such as nano-electronics fusion techniques, biological imaging, medical treatment, etc. Particularly, superparamagnetic iron oxide nanoparticles have been widely used for numerous biomedical applications such as magnetic resonance imaging (MRI), cell-level treatment, hyperthermia, drug delivery, cell separation, amino acid separation, etc.

The most important requirement for the use of nanoparticles in medical applications is to secure high-quality nanoparticles and, in addition, the nanoparticles should have a good dispersity in biological media and a dispersion stability in aqueous media. The “high-quality nanoparticles” requires i) monodispersity of nanoparticle size, ii) ease of nanoparticle size control, iii) crystallinity of nanoparticles, and iv) controllability of nanoparticle shape.

However, nanoparticles which are commercially available at present are mostly synthesized in aqueous media or in a gas phase, and most of such nanoparticles have poor shape-uniformity and crystallinity. In addition, it is difficult to produce monodisperse nanoparticles and control particle size as well.

Recently, many researchers have developed methods of synthesizing high-quality metal oxide nanoparticles in organic solvent, with monodispersity and crystallinity compared to those prepared in aqueous media.

When nanoparticles are synthesized in organic solvent, monodispersity and size control of the nanoparticles is sometimes achieved through stabilization procedure by adding an organic additive during synthetic procedure. Consequently, since the surface condition of nanoparticles are influenced by the hydrophobic portion of the organic additive, metal oxide nanoparticles are easily dispersed into hydrophobic organic solvent but not into water and, therefore, when dispersing the metal oxide nanoparticles into water, the dispersion state is not sufficiently stable.

Since the hydrophobicity of the surface of the nanoparticles prepared in organic solvent prevent the nanoparticles from being dispersed into aqueous media, it is disadvantageous to use the nanoparticles in biomedical application. Therefore, in order for the nanoparticles to be applicable to the biomedical application, it has been required to develop a biocompatible suspension stabilizer which enables the nanoparticles to be uniformly dispersible in aqueous media by modifing the surface of the nanoparticles to be hydrophilic. It has been also required to develop a nanoparticle suspension stabilizer which can keep a dispersion stable by using such biocompatible suspension stabilizer.

The biocompatible suspension stabilizer for dispersing inorganic nanoparticles in aqueous media, according to the present invention, modifies the surface of the inorganic nanoparticles to be hydrophilic, thereby stabilizing the inorganic nanoparticles in the aqueous media and allowing the inorganic nanoparticles to be applicable to biomedical field. Thus, inorganic nanoparticles which are stabilized in aqueous media can be provided by using the biocompatible suspension stabilizer.

Inorganic nanoparticles of which dispersion state is stabilized by the biocaompatible suspension stabilizer for inorganic nanoparticles into aqueous media, according to the present invention, can be applied to nanoelectronics such as quantum dot (Q-dot) light-emitting device, etc., biological imaging such as MRI contrasting agent, etc., tissue engineering such as cell-level treatment, etc., biomedical applications such as hyperthermia, drug delivery, etc.

Recently, method for dispersing nanoparticles into water by using thin silica shell was reported in Journal of Chemical Society, 2005, 127, 4990, which is based on the conventional method for dispersing inorganic nanoparticles into aqueous media. In this document, silica-coated nanoparticles were dipersed into water by the method comprised of mixing nanoparticles prepared in organic solvent with solution of polyoxyethylene nonylphenyl ether and cyclohexane to form microemulsion droplet micelles and, then, coating the nanoparticles with silica by sol-gel reaction of tetraethyl orthosilicate (TEOS).

The document describes a procedure of coating nanoparticles with hydrophilic silica. The procedure has a disadvantage that only a small amount of water-dispersible nanoparticles can be produced in a single reaction process by the procedure since the amount of the nanoparticles which can be coated with silica in a single reaction process by microemulsion technique is very small.

The procedure also has a disadvantage that it is difficult to control accurately the thickness of the silica shell as wanted since conditions of microemulsion varies depending on the amount of the nanoparticles prepared in a single process and the amount of polyoxyethylene nonylphenyl ether being used. It is also difficult to achieve size uniformity of the nanoparticles since the number of the nanoparticles encapsulated with silica varies. Furthermore, according to the conventional techniques, silane groups on the surface of silica which are not sufficiently stable react each other and, therefore, nanoparticles which are coated with silica and dispersed in water tend to aggregate with the passage of time, when the nanoparticles are stabilized by forming silica layer on the nanoparticles. Consequently, it is difficult to ensure the storage stability of the nanoparticles.

Moreover, method of dispersing nanoparticles in water by using dendron ligands having poly(ethylene glycol) tail groups has been recently reported (Advanced Materials, 20005, 17, 1429). In this method, dendron ligands having PEG tail groups were mixed with nanoparticles dipersed in hydrophobic solvent and, then, the mixture was treated several times via ligand exchange method using ultrasonic waves, thereby binding the dendron ligands on the surface of the nanoparticles and stabilizing the nanoparticles. Thereafter, the stabilized nanoparticles were dispersed in water.

In the above mentioned technique, the ligand exchange method which is somewhat easy to perform was utilized. However, the dendron ligands having PEG tail groups are synthesized through sophisticated multi-step procedures and yield of the ligand is low. Therefore, it is difficult to scale-up this technique to a commercial scale.

In addition, iron oxide nanoparticles which are coated with biocompatible polymer and stabilized in an aqueous medium are disclosed in U.S. Pat. No. 5,492,814 filed by Ralph Weisslder in 1996. The document describes that the stabilized iron oxide nanoparticles are produced through the reduction of iron chloride in a dextran phase.

When using this method, iron oxide nanoparticles encapsulated with biocompatible polymers can be synthesized via relatively simple synthetic procedure. However, the size distribution of the as-synthesized nanoparticles is broad and the quality of the nanoparticles is poor. Moreover, it is difficult to control their sizes and their sizes are as large as hundreds nanometer.

Recently, method of dispersing nanoparticles in water by using phosphine oxide and poly(ethylene glycol) has been reported in Journal of American Chemical Society, 2005, 127, 4556. In this method, poly(ethylene glycol) is reacted with 1,2-bis(dichlorophosphino)ethane to synthesize polymer in which poly(ethylene glycol) molecules are bined one another and, then, nanoparticles are stabilized through ligand exchange method of the polymer with nanoparticles dispersed in a hydrophobic solvent. The thus prepared nanoparticles are uniformly dispersed in water.

This method is relatively simple and nanoparticles are dispersed in water through the ligand exchange method. However, this method has a problem that polymers for coating should be produced in an inert atmosphere by using argon or nitrogen since phosphine atom is easily oxidezed to phosphoryl. Furthermore, this method still has another problem that in vivo function groups such as DNA, RNA, monoclonal antibody or other functional proteins cannot be easily introduced to the nanoparticles since the polymers are cross-linked.

### DISCLOSURE

### Technical Problem

Therefore, in order to overcome the above-mentioned problems of the conventional techniques, the primary object of the present invention is to provide a suspension stabilizer which can easily introduce ligands with bioactivity so that the suspension stabilizer may be applicable to biomedical applications through the modification of the surface of inorganic nanoparticles to be hydrophilic and the stabilization of the nanoparticles in an aqueous medium. That is, the primary object of the present invention is to provide a biocompatible suspension stabilizer comprising phosphoryl group, which can be synthesized in a non-inert atmosphere; of which biocompatible polymers do not cross-link; and to which an active portion being able to conjugate with bioactive ligands is introduced.

Another object of the present invention is to provide a method for preparing a suspension stabilizer comprising phosphory group, which comprises: i) dissolving a biocompatible polymer in an organic solvent to prepare a biocompatible polymer solution; ii) adding phosphine oxide having a leaving group to said biocompatible polymer solution prepared in the step i) to form a bond between said phosphine oxide and said biocompatible polymer; and iii) introducing a bioactive ligand to the position of said leaving group of said phosphine oxide which is bonded to said biocompatible polymer, by reacting said phosphine oxide-bonded biocompatible polymer of the step ii) with a substance having a functional group which can bind to a bioactive ligand.

### Technical Solution

The above-mentioned primary object of the present invention, in order to modify the surface of inorganic nanoparticles to be hydrophilic and disperse the inorganic nanoparticles in an aqueous medium, can be achieved by providing a phosphine oxide compound of the following formula (I), which comprises polyethylene glycol-derivatized polymer and phosphryl group:

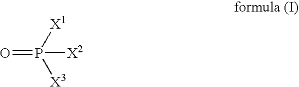

where X¹ and X² are (OCH₂CH₂)ₙOH, (OCH(CH₃)CO)ₙOH or (OCH₂CO)ₙOH, n is an integer from 1 to 50, X³ is OH, (OCH²)ₘOH, (OCH₂CH₂)ₘOH, (NCH)ₘNH₂, (NCH₂CH₂NH)ₘH, S(CH₂)ₘSH or NHCH₂CH₂CH₂(OCH₂CH₂)₃₄OCH₂CH₂CH₂NH₂, and m is an integer from 1 to 5; or

X¹ is (OCH₂CH₂)ₙOH, (OCH(CH₃)CO)ₙOH or (OCH₂CO)ₙOH, n is an integer from 1 to 50, X² is OH, (OCH²)ₘOH, (OCH₂CH₂)ₘOH, (NCH₂)ₘNH₂, (NCH₂CH₂NH)ₘH, S(CH₂)ₘSH or NHCH₂CH₂CH₂(OCH₂CH₂)₃₄OCH₂CH₂CH₂NH₂, and m is an integer from 1 to 5, and X³ is OH.

The term “biocompatible polymer” of the present invention refers to a polymer that has tissue and blood compatibility, namely that does not necrotize tissue coagulate blood when contacting tissue and blood.

The biocompatible polymer includes polyurethane, PVC, polycarbonate, polytetrafluoroethylene, polypropylene, silicon, polymethylmethacrylate, polyamide, cellulose, polyester, polylactic acid (PLA), polyglycolic acid (PGA), poly(lactic-co-glycolic acid) (PLGA), etc.

In the present invention, polyethylene glycol-derivatized polymers, polylactic acid and polyglycolic acid are used as the biocompatible polymer.

In addition, the term “leaving group” of the present invention refers to an ion (or an atom) or a group of atoms that detach itself from a molecule. The leaving groups of the present invention is preferably selected from halo, TsO⁻, N₃⁻, NH₃, S⁻, SiO⁻, CH₃COO⁻, etc., more preferably from halo, and most preferably from Cl⁻.

Another object of the present invention can be achieved by providing a method for preparing a phosphine oxide compound of the above formula (I), which comprises: i) dissolving a biocompatible polymer in an organic solvent to prepare a biocompatible polymer solution; ii) adding phosphine oxide having a leaving group to said biocompatible polymer solution prepared in the step i) to form a bond between said phosphine oxide and said biocompatible polymer; and iii) introducing a bioactive ligand to the position of said leaving group of said phosphine oxide which is bonded to said biocompatible polymer, by reacting said biocompatible phosphine oxide-bonded polymer of the step ii) with a substance having a functional group which can bind to a bioactive ligand.

A compound of the following formula (II) may be obtained by the method comprising: dissolving a biocompatible polymer such as polyethylene glycol in an organic solvent such as tetrahydrofuran to prepare a biocompatible polymer solution and, then, adding a compound containing phosphine oxide group, such as phosphoryl chloride, to said biocompatible polymer solution at room temperature.

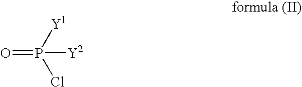

In the compound of formula (II), Y¹ and Y² are (OCH₂CH₂)ₙOH, (OCH(CH₃)CO)ₙOH or (OCH₂CO)ₙOH, n is an integer from 1 to 50; or
Y¹ is (OCH₂CH₂)ₙOH, (OCH(CH₃)CO)ₙOH or (OCH₂CO)ₙOH, n is an integer from 1 to 50, and Y² is Cl.

The compound of formula (I) may be produced by reacting the solution containing the compound of formula (II) with a biocompatible polymer having multi-functional groups, selected from C₁₋₅ alkyldiol (HO(CH₂)ₙOH, n=1 to 5)) such as 1,2-ethyleneglycol and 1,3-propyleneglycol; C₂, C₄, C₆, C₈ and C₁₀ ethylene glycol (H(OCH₂CH₂)ₙOH, n=1 to 5) such as diethyleneglycol and triethyleneglycol; C₁₋₅ alkyldiamine (H₂N(CH₂)ₙNH₂, n=1 to 5) such as 1,2-ethylenediamine and 1,3-propylenediamine; C₂, C₄, C₆, C₈ and C₁₀ ethylenediamine (H₂N(CH₂CH₂NH)ₙH, n=1 to 5) such as diethylenediamine and triethylenediamine; C₁₋₅ alkyldithiol (HS(CH₂)ₙSH, n=1 to 5) such as 1,2-ethylenedithiol and 1,3-propylenedithiol; or poly(ethylene glycol) bis(3-aminopropyl) terminated, in order to introduce a ligand which can conjugate with functional ligands such as DNA, RNA, monoclonal antibody, etc.

Biocompatible polyethylene glycol-derivatized polymer for dispersing and stabilizing inorganic nanoparticles in aqueous media of the present invention has, preferably, a number-average molecular weight (Mₙ) ranging from 300 to 20,000.

The suspension stabilizer of the present invention, which contains biocompatible polyethylene glycol-derivatized polymer and phosphoryl group may be used to disperse inorganic nanoparticles into aqueous media and stabilize the inorganic nanoparticles in the aqueous media.

The inorganic nanoparticles being stabilized by the biocompatible suspension stabilizer comprising phosphoryl group of the present invention are preferably selected from magnetite (Fe₃O₄), maghemite (gamma-Fe₂O₃), CoFe₂O₄, MnFe₂O₄, Fe—Pt alloy, Co—Pt alloy, Co, CdSe, CdTe, CdSe/ZnS core/shell, CdSe/ZnSe core/shell, CdSe/CdS core/shell, CdTe/ZnS core/shell, CdTe/ZnSe core/shell, CdTe/CdS core/shell, CdTe/CdSe core/shell, ZnS, CdS, InAs, InP, InAs/InP core/shell, InAs/CdSe core/shell, InAs/ZnS core/shell, InAs/ZnSe core/shell, InP/CdSe core/shell, InP/ZnS core/shell, InP/ZnSe core/shell, Au, Pd or Pt.

The biocompatible polymer used in the step i) of the method for preparing the biocompatible suspension stabilizer with phosphory group for dispersing inorganic nanoparticles into aqueous medium of the present invention may be preferably selected from polyethylene glycol) (PEG), poly(lactic acid) (PLA), poly(glycolic acid) (PGA), etc.

The leaving groups bonded to phosphine oxide being used in the step ii) of the method for preparing the biocompatible suspension stabilizer with phosphory group for dispersing inorganic nanoparticles into aqueous medium of the present invention are the same as described above.

Another object of the present invention can be achieved by providing a method for preparing the biocompatible suspension stabilizer with phosphoryl group for dispersing inorganic nanoparticles into aqueous medium of the present invention, the method further comprising reacting a surfactant prepared by the present invention with an additive in order to introduce a functional group to the surfactant.

### ADVANTAGEOUS EFFECTS

According to the present invention, a biocompatible suspension stabilizer which can disperse stably inorganic nanoparticles into aqueous media by modifying the surface of the inorganic nanoparticles may be synthesized. The thus-prepared biocompatible suspension stabilizer can disperse stably inorganic nanoparticles into aqueous solution and, thereby, can be applicable to nanoelectronics such as quantum clot (Q-dot) light-emitting device, etc., biological imaging such as MRI contrasting agent, etc., tissue engineering such as cell-level treatment, etc., biomedical applications such as hyperthermia, drug delivery, etc. Moreover, the inorganic nanoparticles dispersed by the suspension stabilizer show excellent suspension stability, compared to those dispersed by the conventional suspension stabilizer.

### DESCRIPTION OF DRAWINGS

FIG. 1 shows a stepwise synthetic route of PEG-based suspension stabilizer containing phosphoryl group of the present invention.

FIG. 2 shows TEM (transmission electron microscopy) images of iron oxide dispersed stably in water (right) by the biocompatible suspension stabilizer of the present invention, and dispersed in hydrophobic solvent (left) before the stabilization by using the biocompatible suspension stabilizer of the present invention.

FIG. 3 shows images of various inorganic nanoparticles which are dispersed and stabilized in water by using the biocompatible suspension stabilizer of the present invention.

FIG. 4 shows an image of magnetically attracted iron oxide nanoparticles dispersed and stabilized in water with high iron concentration by using the biocompatible suspension stabilizer of the present invention.

FIG. 5 shows an image of fluorescein isothiocyanate (FITC)-conjugated iron oxide nanoparticles dispersed in water under UV irradiation. The FITC-conjugated iron oxide nanoparticles were prepared as follows: dispersing iron oxide nanoparticles into water by using biocompatible amine-functionalized suspension stabilizer and, then, reacting functional groups on the surface of the nanoparticles with FITC to prepare fluorescence-probing magnetic nanoparticles with green-fluorescence property.

FIG. 6 shows TEM images of phosphine oxide-polyethylene glycol) (PO-PEG) stabilized metal oxide nanoparticles dispersed in water: a) CoO, b) NiO, c) MnO and d) TiO₂.

FIG. 7 shows mass analysis data of (a) mPEG (methyl-polyethylene glycol, Mₙ=750) which is a reactant of the first step reaction in FIG. 1 and (b) the compound of formula (II) which is a product of the first step in FIG. 1, obtained by using MALDI-TOF (matrix assisted laser desorption ionization time-of-flight).

FIG. 8 shows ³¹P NMR spectra of the compounds of formula (I) when mPEGs, the reactants of the second step of FIG. 1, with molecular weight of (a) 550, (b) 750 and (c) 2,000 were used. CDCl₃ and D₂O were used as a solvent to obtain left spectra and right spectra, respectively.

FIG. 9 shows ³¹P NMR spectra of (a) POCl₃ in CDCl₃, (b) product of the first step of FIG. 1 from the reaction of POCl₃ with mPEG (molecular weight=2,000) and (c) product of the second step of FIG. 1 from the reaction of the product of (h) with ethylenediamine.

### BEST MODE

Hereinafter, the technical elements and features of the present invention will be described in greater detail with reference to the following examples. However, the examples are given only for illustration of the present invention and not to be limiting the present invention.

TEM image of iron oxide nanoparticles dispersed in water (right) by using a biocompatible suspension stabilizer of the present invention and TEM image of iron oxide nanoparticles dissolved in hydrophobic solvent before ligand exchange (left) are shown in FIG. 2.

Referring to in FIG. 2, it can be known that the shape and size of the iron oxide nanoparticles dispersed stably in water by using a biocompatible suspension stabilizer of the present invention and the iron oxide nanoparticles dissolved in hydrophobic solvent before ligand exchange are the same each other. These results shows that the shape and size of the iron oxide nanoparticles were not changed after ligand exchange.

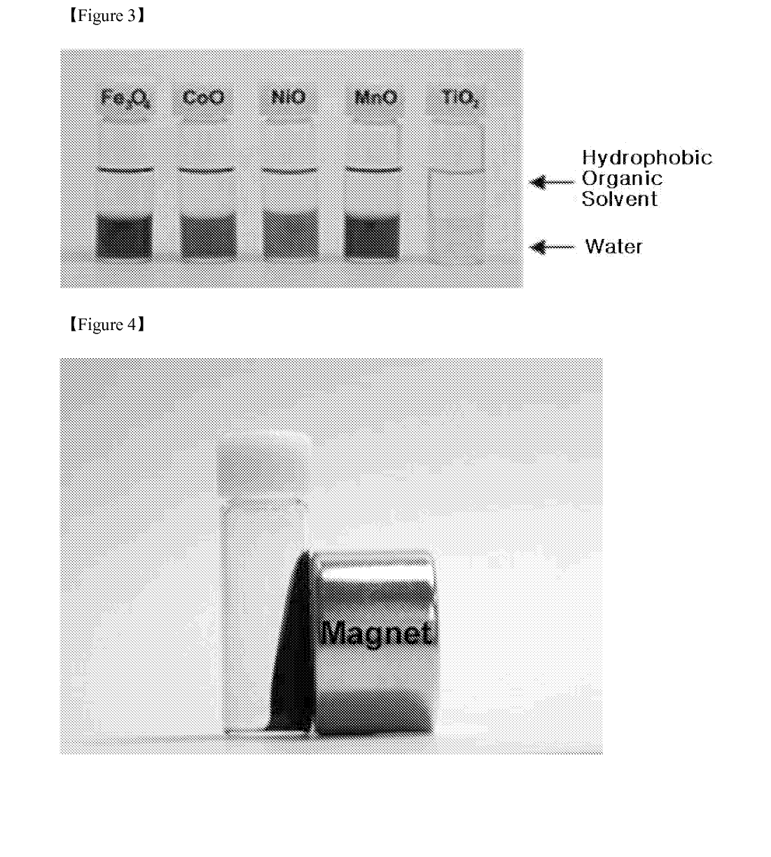

FIG. 3 shows that various inorganic nanoparticles were stably dispersed in water by using the biocompatible suspension stabilizer of the present invention. It can be appreciated from these results that the biocompatible suspension stabilizer of the present invention can disperse stably various nanoparticles in water and the dispersion stability of the nanoparticles is kept for a long time.

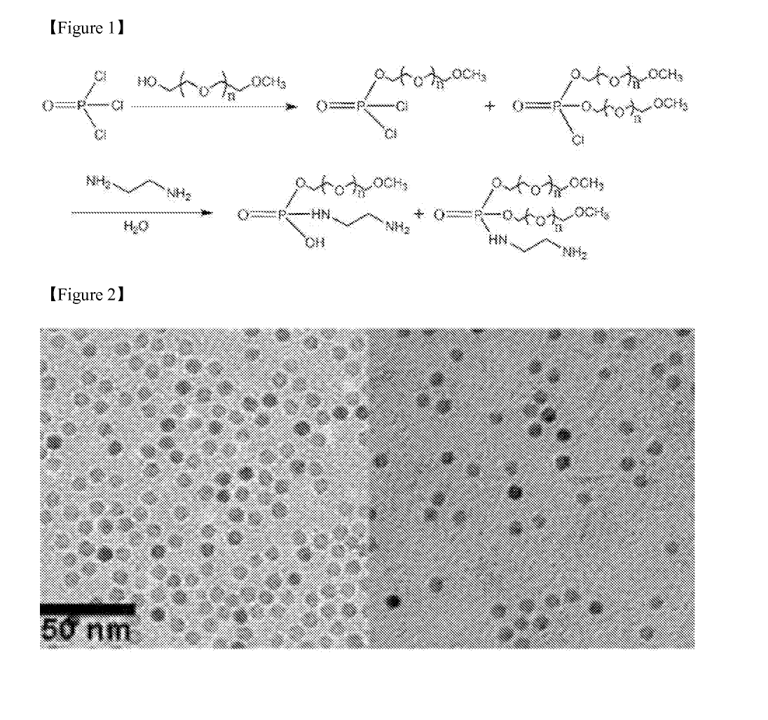

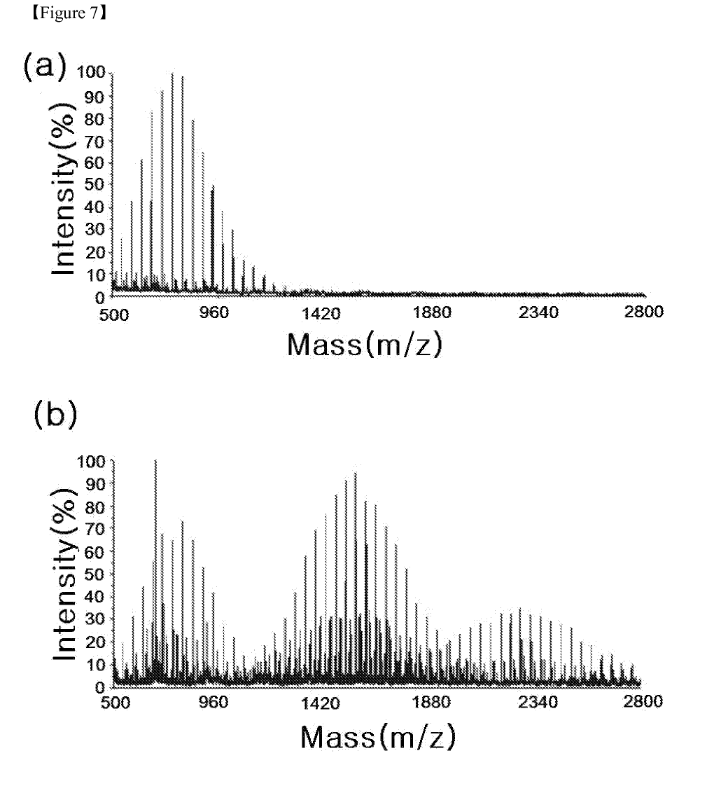

FIG. 7 shows mass analysis data of (a) mPEG (methyl-polyethylene glycol, Mₙ=750) which is a reactant of the first step reaction in FIG. 1 and (b) the compound of formula (II) which is a product of the first step in FIG. 1, obtained by using MALDI-TOF (matrix assisted laser desorption ionization time-of-flight). It can be known from the data of FIG. 7 that PO-PEG bonded with one, two and three mPEGs, respectively, were produced. PO-PEG in the present specification refers to a compound resulting from the bonding of phosphine oxide and PEG.

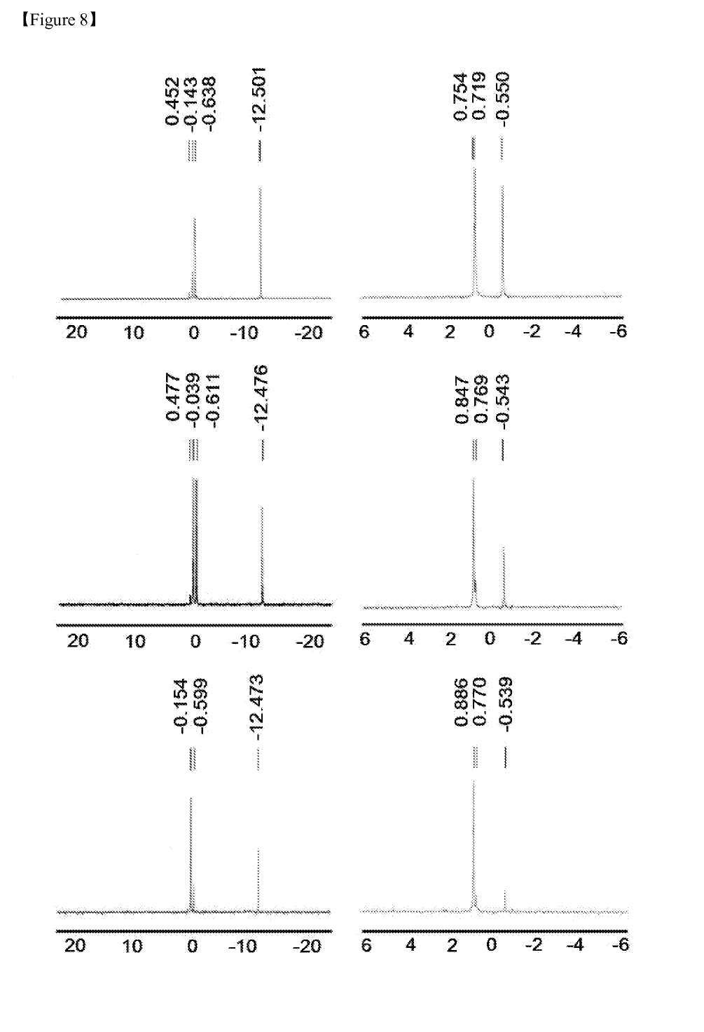

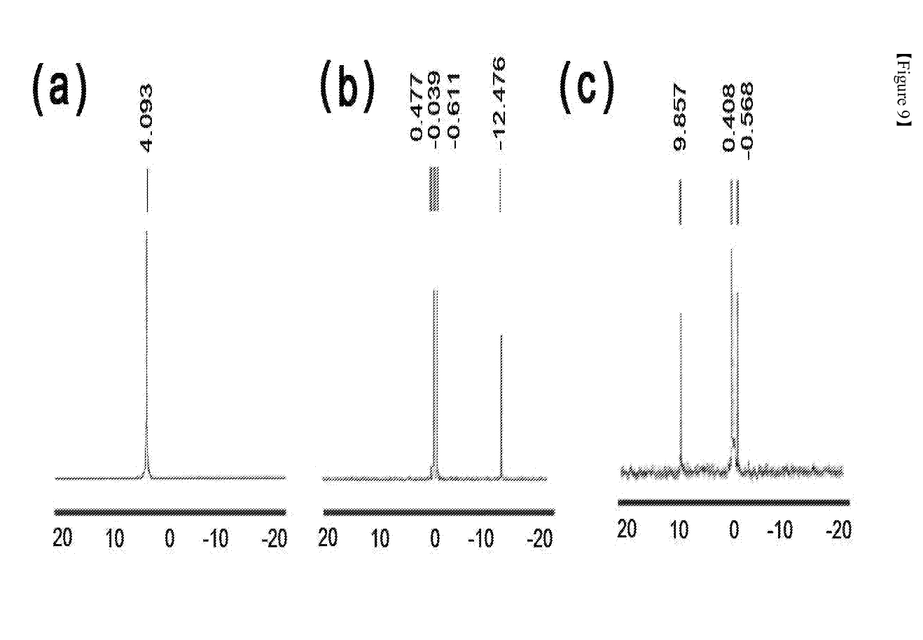

FIG. 8 shows ³¹P NMR spectra of the compounds of formula (I) when mPEGs, the reactants of the second step of FIG. 1, with molecular weight of (a) 550, (b) 750 and (c) 2,000 were used. CDCl₃ and D₂O were used as a solvent to obtain left spectra and right spectra, respectively. It can be interpreted from the data of FIG. 8 that the peak near −10 is due to the P—Cl bond of unreacted phosphoryl oxide.

FIG. 9(a) shows a characteristic peak of POCl₃. FIG. 9(b) shows three peaks of the products bonded with one, two and three mPEGs, respectively, and a peak of unreacted P—Cl near −12. FIG. 9(c) which relates the product of the second step of FIG. 1 shows three peaks in the middle of the spectrum and a new peak near 9.8, which originates from P—N bond of the product.

In order to describe the application of biocompatible suspension stabilizer having phosphoryl group and the leaving group of the present invention, magnetic nanoparticles and FITC, a green fluorescent dye, were reacted with iron oxide nanoparticles stabilized with the biocompatible suspension stabilizer having phosphory group and, then, fluorescent property of the FITC-conjugated iron oxide nanoparticles was tested.

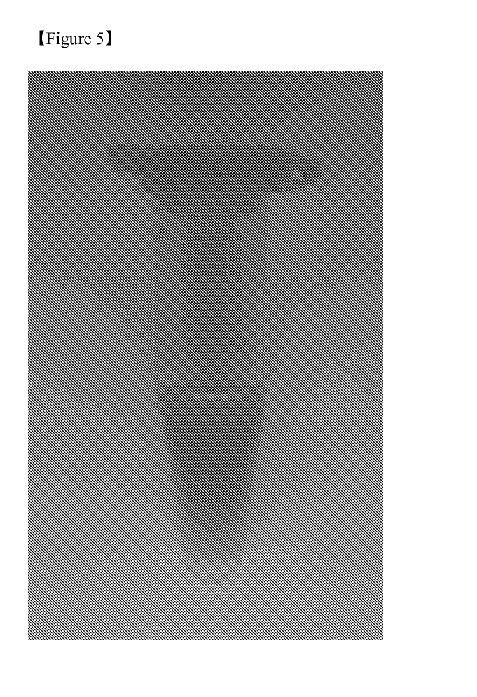

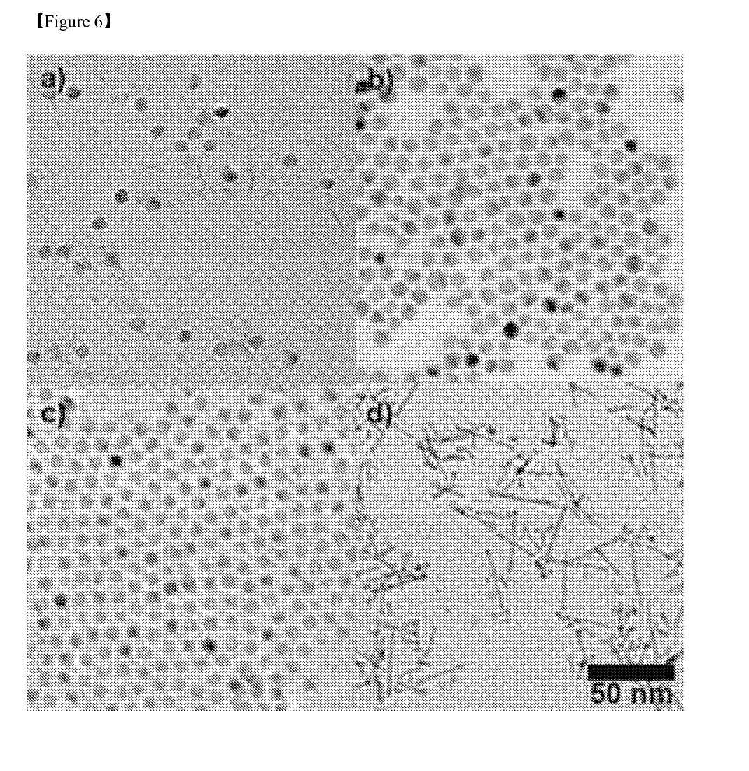

Amine-functionalized PEG surfactant was first synthesized by reacting PEG surfactant having phosphory group with 1,2-ethylenediamine. Iron oxide nanoparticles were treated and stabilized with the surfactant and, then, dispersed into water. Fluorescence-probing magnetic nanoparticles with green-fluorescence property were produced by the reaction of amine groups introduced on the surface of the nanoparticles with FITC. FIG. 5 shows an image of FITC-conjugated iron oxide nanoparticles dispersed in water under UV irradiation.

### Example 1

### Synthesis of PEG-Derivatized Suspension Stabilizer Having Phosphoryl Group

10 g of poly(ethylene glycol) methyl ether (mPEG) with molecular weight of 2,000 was dissolved into 20 ml of tetrahydrofuran (THF) and 0.16 ml of phosphoryl chloride was added to the mPEG solution and the resulting reaction mixture was stirred at room temperature. After stirred for 12 hours, THF was evaporated and the resulting adduct was maintained at 100° C. under vacuum for 12 hours. Then, the vacuum was released and the product was cooled to room temperature.

### Example 2

### Synthesis of PEG-Derivatized Suspension Stabilizer Having Amine Group and Phosphoryl Group

6.7 g of poly(ethylene glycol) methyl ether (mPEG) with molecular weight of 2,000 was dissolved into 20 ml of THF and 0.16 ml of phosphoryl chloride was added to the mPEG solution and the resulting reaction mixture was stirred at room temperature. After stirred for 12 hours, THF was evaporated and the resulting adduct was maintained at 100° C. under vacuum for 12 hours. Then, the vacuum was released and 20 ml of THF was added to the resulting adduct. 0.3 to 1.0 ml of 1,2-ethylenediamine was added to the resulting adduct and, then, the thus prepared solution was stirred at room temperature for 12 hours. After stirred for 12 hours, THF was evaporated and the thus prepared adduct was maintained at 100° C. under vacuum for 12 hours. Then, the vacuum was released and the product was cooled to room temperature.

### Example 3

### Synthesis of Magnetic Iron Oxide Nanoparticles Stabilized with PEG-Derivatized Suspension Stabilizer Having Phosphoryl Group

50 mg of magnetic nanoparticles (Fe₃O₄) which were synthesized in an orgnaic solvent and stabilized with oleic acid were dispersed into 10 ml of THF, and 1 g of phosphory-functionalized PEG-derivatized suspension stabilizer dissolved in 5 ml of THF was added to the magnetic nanoparticle dispersion. THF was evaporated and the resulting adduct was maintained at 150 under vacuum for 1 hour. Then, vacuum was released and the product was cooled to room temperature. 10 ml of distilled water was added to the product and the resulting dispersion was filtered by using a 200 nm syringe filter.

### Example 4

### Synthesis of Photocatalytic Titanium Oxide Nanoparticles Stabilized with Peg-Derivatized Suspension Stabilizer Having Phosphoryl Group

10 mg of photocatalytic titanium oxide nanoparticles synthesized in an organic solvent in a similar manner as Example 3 were stabilized with a phosphoryo-functionalized PEG-derivatized suspension stabilizer and then dispersed into water.

### Synthesis of Manganese Oxide Nanoparticles Stabilized with PEG-Derivatized Suspension Stabilizer Having Phosphoryl Group

10 mg of manganese oxide nanoparticles synthesized in an organic solvent in a similar manner as Example 3 were stabilized with a phosphoryo-functionalized PEG-derivatized suspension stabilizer and then dispersed into water.

1. A phosphine oxide compound of the following formula (I): 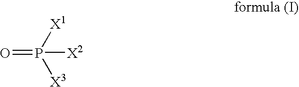
where X¹ and X² are (OCH₂CH₂)ₙOH, (OCH(CH₃)CO)ₙOH or (OCH₂CO)ₙOH, n is an integer from 1 to 50, X³ is OH, (OCH²)ₘOH, (OCH₂CH₂)ₘOH, (NCH₂)ₘNH₂, (NCH₂CH₂NH)ₘH, S(CH₂)ₙSH or NHCH₂CH₂CH₂(OCH₂CH₂)₃₄OCH₂CH₂CH₂NH₂, and m is an integer from 1 to 5; or
X¹ is (OCH₂CH₂)ₙOH, (OCH(CH₃)CO)ₙOH or (OCH₂CO)ₙOH, n is an integer from 1 to 50, X² is OH, (OCH₂)ₘOH, (OCH₂CH₂)ₘOH, (NCH₂)ₘNH₂, (NCH₂CH₂NH)ₘH, S(CH₂)ₘSH or NHCH₂CH₂CH₂(OCH₂CH₂)₃₄OCH₂CH₂CH₂NH₂, and m is an integer from 1 to 5, and X³ is OH.

2. A method for preparing a phosphine oxide compound of the above formula (I), which comprises:
i) dissolving a biocompatible polymer in an organic solvent to prepare a biocompatible polymer solution;
ii) adding phosphine oxide having a leaving group to said biocompatible polymer solution prepared in the step i) to form a bond between said phosphine oxide and said biocompatible polymer; and
iii) introducing a bioactive ligand to the position of said leaving group of said phosphine oxide which is bonded to said biocompatible polymer, by reacting said phosphine oxide-bonded biocompatible polymer of the step ii) with a substance having a functional group which can bind to a bioactive ligand.

3. The method of claim 2, wherein said biocompatible polymer is selected from the group consisting of poly(ethylene glycol), poly(lactic acid) and poly(glycolic acid).

4. The method of claim 2, wherein said leaving group is selected from the group consisting of halogen, TsO⁻, N₃⁻, NH₃, S⁻, SiO⁻ and CH₃COO⁻.

5. The method of claim 2, wherein said substance having a functional group is selected from the group consisting of C₁₋₅ alkyldiol (HO(CH₂)ₙOH, n=1 to 5)); C₂, C₄, C₆, C₈ and C₁₀ ethylene glycol (H(OCH₂CH₂)ₙOH, n=1 to 5); C₁₋₅ alkyldiamine (H₂N(CH₂)ₙNH₂, n=1 to 5); C₂, C₄, C₆, C₈ and C₁₀ ethylenediamine (H₂N(CH₂CH₂NH)ₙH, n=1 to 5); C₁₋₅ alkyldithiol (HS(CH₂)ₙSH, n=1 to 5); and poly(ethylene glycol) bis(3-aminopropyl) terminated.

6. A suspension stabilizer for dispersing inorganic nanoparticles into aqueous medium, which comprises a phosphine oxide compound of the following formula (I): 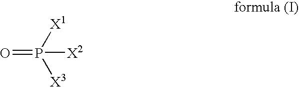
where X⁻, X⁻ and X⁻ are the same as defined in claim 1.

7. The suspension stabilizer of claim 6, wherein said inorganic nanoparticle is selected from the group consisting of magnetite (Fe₃O₄), maghemite (gamma-Fe₂O₃), CoFe₂O₄, MnFe₂O₄, Fe—Pt alloy, Co—Pt alloy, Co, CdSe, CdTe, CdSe/ZnS core/shell, CdSe/ZnSe core/shell, CdSe/CdS core/shell, CdTe/ZnS core/shell, CdTe/ZnSe core/shell, CdTe/CdS core/shell, CdTe/CdSe core/shell, ZnS, CdS, InAs, InP, InAs/InP core/shell, InAs/CdSe core/shell, InAs/ZnS core/shell, InAs/ZnSe core/shell, InP/CdSe core/shell, InP/ZnS core/shell, InP/ZnSe core/shell, Au, Pd and Pt.

8. A method for preparing a suspension stabilizer of the above formula (I), which comprises:
i) dissolving a biocompatible polymer in an organic solvent to prepare a biocompatible polymer solution;
ii) adding phosphine oxide having a leaving group to said biocompatible polymer solution prepared in the step i) to form a bond between said phosphine oxide and said biocompatible polymer; and
iii) introducing a bioactive ligand to the position of said leaving group of said phosphine oxide which is bonded to said biocompatible polymer, by reacting said phosphine oxide-bonded biocompatible polymer of the step ii) with a substance having a functional group which can bind to a bioactive ligand.

9. The method of claim 8, wherein said biocompatible polymer is selected from the group consisting of poly(ethylene glycol), poly(lactic acid) and poly(glycolic acid).

10. The method of claim 8, wherein said leaving group is selected from the group consisting of halogen, TsO⁻, N₃⁻, NH₃, S⁻, SiO⁻ and CH₃COO⁻.

11. The method of claim 8, wherein said substance having a functional group is selected from the group consisting of C₁₋₈ alkyldiol (HO(CH₂)ₙOH, n=1 to 5)); C₂, C₄; C₆; C₈ and C₁₀ ethylene glycol (H(OCH₂CH₂)ₙOH, n=1 to 5); C₁₋₅ alkyldiamine (H₂N(CH₂)ₙNH₂, n=1 to 5); C₂, C₄, C₆, C₈ and C₁₀ ethylenediamine (H₂N(CH₂CH₂NH)ₙH, n=1 to 5); C₁₋₅ alkyldithiol (HS(CH₂)ₙSH, n=1 to 5); and poly(ethylene glycol) bis(3-aminopropyl) terminated.

12. A phosphine oxide compound of the following formula (II): 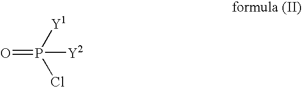
where Y¹ and Y² are (OCH₂CH₂)ₙOH, (OCH(CH₃)CO)ₙOH or (OCH₂CO)ₙOH, n is an integer from 1 to 50; or
Y¹ is (OCH₂CH₂)ₙOH, (OCH(CH₃)CO)ₙOH or (OCH₂CO)ₙOH, n is an integer from 1 to 50, and Y² is Cl.

13. A method for preparing a phosphine oxide compound of the above formula (II), which comprises:
i) dissolving a biocompatible polymer in an organic solvent to prepare a biocompatible polymer solution; and
ii) adding phosphine oxide having a leaving group to said biocompatible polymer solution prepared in the step i) to form a bond between said phosphine oxide and said biocompatible polymer.

14. The method of claim 13, wherein said biocompatible polymer is selected from the group consisting of poly(ethylene glycol), poly(lactic acid) and poly(glycolic acid).

15. The method of claim 13, wherein said leaving group is selected from the group consisting of halogen, TsO⁻, N₃⁻, NH₃, S⁻, SiO⁻ and CH₃COO⁻.
